(19) United States
(12) Patent Application Publication
(10) Pub. No.: US 2004/0106725 A1
(43) Pub. Date: Jun. 3, 2004

(54) Active small diameter polystyrene seed latex for continuous emulsion polymerization

(75) Inventors: Jonathan P. Antonucci, Rock Hill, SC (US); Michael A. Taylor, Rock Hill, SC (US); Koichi Takamura, Charlotte, NC (US); Robert Racz, Charlotte, NC (US)

Correspondence Address: BASF CORPORATION, ANNE GERRY SABOURIN, 26701 TELEGRAPH ROAD, SOUTHFIELD, MI, 48034-2442, US

(73) Assignee: BASF AG

(21) Appl. No.: 09/850,754

(22) Filed: May 8, 2001

(51) Int. Cl. C08K 3/20

(52) U.S. Cl. 524/577; 524/836

(57) ABSTRACT

A polystyrene seed latex composition is provided having a total emulsion polymer content of from 0.2 to 2.0 weight percent and a particle diameter less than 150 Å. The seed latex is produced on a continuous basis by feeding to a continuous stirred reactor an emulsion stream and initiator stream. The feed streams are mixed in the stirred reactor at room temperature to produce the seed latex. Preferably, the initiator stream comprises a sodium formaldehyde sulfoxylate reducing agent. The amount of initiator charged into the continuous seed reactor is sufficient to complete both the seed and a subsequent continuous latex polymerization reaction.

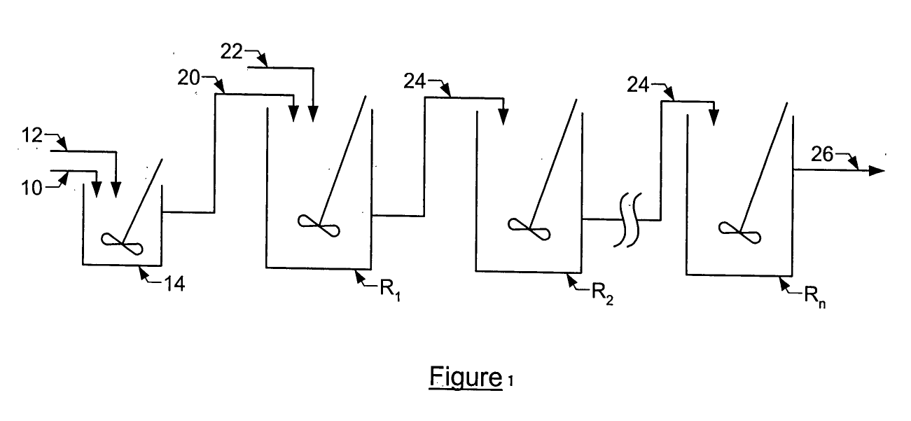

### FIELD OF THE INVENTION

This invention relates to the preparation of a polystyrene seed latex composition and to a latex polymer produced from such a seed latex composition.

### BACKGROUND OF THE INVENTION

Latex polymers of the type used in adhesives, coatings, foam products and asphalt modifiers for example, are conventionally produced by emulsion polymerization, which is carried out either batchwise or continuously. In a continuous emulsion polymerization process, a series of continuous stirred tank reactors is employed for producing the latex composition.

Continuous emulsion polymerization is subject to the problem of periodic cycling of both the average particle diameter and reaction kinetics. It has been shown that this problem can be partially addressed by seeding the process with small diameter polymer particles. For example, Berens, A. R., J. App. Polym. Sci., 1974, 18, 2379-2390 describes an early model for continuous emulsion polymerization using seed to help achieve steady state conditions. The kinetics of seeded continuous tubular reactors has also been studied and reported in the following additional publications: Golzales, R. A., M. Sc. Thesis, 1974, Chem. Engr. Dept., Lehigh University; Lee, H.; Poehlein, G. W., J. Dispersion, Sci. & Tech., 1984, 247-265; Lin, C. C., Chiu, W. Y., J. Chinese Inst. Chem. Eng., 1982, 13, 151-153; and Poehlein, G. W.; Dubner, W.; Lee, H., British Polym. J., 1982, 143-152.

### SUMMARY OF THE INVENTION

In accordance with the present invention, a novel emulsion polymer seed composition has been developed to further control and moderate the polymerization kinetics and produce a more consistent latex product. The seed latex composition has very small diameter particles and a low polymer concentration.

More particularly, the present invention provides a polystyrene seed latex composition having a total emulsion polymer content of from 0.2 to 2.0 weight percent and a particle diameter less than 150 Å. The seed composition also desirably includes sufficient surfactant and initiator for carrying out subsequent continuous polymerization reactions.

The seed latex is produced on a continuous basis by feeding to a continuous stirred reactor an emulsion stream and initiator stream. The feed streams are mixed in the stirred reactor at 15° C. -30° C. to produce the seed latex. Preferably, the initiator stream will use a redox system comprised a sodium formaldehyde sulfoxylate reducing agent. A particularly preferred initiator for below room temperature polymerization comprises a sodium formaldehyde sulfoxylate-iron-ethylene-diamine-tetraacetic acid complex in water, which combines with peroxide in the emulsion stream to form radicals. The amount of initiator charged into the continuous seed reactor is sufficient to complete both polymerization of the seed and also the subsequent continuous latex polymerization reaction using the seed composition.

The emulsion stream comprises 0.2 to 2 percent by weight styrene emulsified by 1 to 8 weight percent potassium oleate in water. The amount of surfactant charged into the continuous seed reactor is sufficient for both the seed polymerization and the subsequent continuous latex polymerization. The high concentration of surfactant, catalyst, peroxide and styrene in water promotes the formation of very small particles.

In a further aspect, the present invention also provides a novel process for producing styrene-butadiene latex using the polystyrene seed latex composition described above. According to this process, a stream of the above-described polystyrene seed latex composition is fed to a continuous stirred reactor or chain or reactors and a monomer stream of styrene and butadiene is also fed to the reactor. The two streams are reacted in the reactor in the absence of additional surfactant or initiator. The seed latex composition provides all the surfactant and initiator required for the polymerization process.

The present invention thus eliminates the need for surfactant and initiator increments during the course of a continuous emulsion polymerization. The novel seed composition of the present invention greatly reduces or eliminates particle generation in a continuous emulsion polymerization. In turn, the absence of generation in the continuous emulsion polymerization reduces the cycling of the final latex particle size and stabilizes the reaction kinetics. The invention also reduces the amount of hydroperoxide needed to initiate and continue emulsion polymerization with a sodium formaldehyde sulfoxylate-iron-ethylene-diamine-tetraacetic acid complex initiation system.

### BRIEF DESCRIPTION OF THE DRAWINGS

Some of the features and advantages of the invention having been described, others will come apparent from the detailed description and examples which follow, and from the accompanying drawings, in which—

The FIGURE is a schematic diagram showing a continuous emulsion polymerization process.

### DETAILED DESCRIPTION OF THE INVENTION

The present invention now will be described more fully with reference to the accompanying drawings and examples, in which illustrative embodiments of the invention are given. This invention may, however, be embodied in many different forms and should not be construed as limited to the specific embodiments set forth herein; rather, these embodiments are provided so that this disclosure will be thorough and complete, and will fully convey the scope of the invention to those skilled in the art.

The polystyrene seed latex composition has a number average particle size less than 150 Å, and preferably in the range from about 70 to 120 Å. The particle size of the latex seed particles may be measured by quasi-elastic light scattering, size exclusion chromatography, scanning electron microscopy or may be deduced from the reaction kinetics of a subsequent polymerization.

The concentration of polymer present in the seed composition is from 0.4 to 2.0 percent by weight. This polymer concentration can be determined by measuring the amount of the monomer present by gas chromatography. The balance of the seed composition comprises emulsifier, initiator, water and additives.

The seed latex composition is produced by continuous emulsion polymerization in a reactor, such as a stirred tank reactor for example. Various kinds of reactors suitable for carrying out continuous polymerization are well-known to those skilled in the art. The polymerization process is carried out by continuously directing two feed streams into the reactor: an emulsion stream consisting of surfactant, water and monomer and an initiator stream. Preferably, the size of the reactor in relation to the feed rates is selected to provide an average residence time in the reactor of 1 to 15 minutes. The average residence time may be readily calculated by dividing the reactor volume by the effluent flow rate.

The emulsion stream or “soap” comprises 0.2 to 2.0 percent styrene emulsified by 1 to 8 percent of an emulsifier. Preferably, the emulsifying agent is potassium oleate, although other suitable emulsifying agents could be employed. The emulsion stream may also include conventional aids and additives such as emulsifying aids, electrolytes, oxygen scavengers, and pH control agents. Hydroperoxide is also added to the emulsion stream to complete the Redox initiator system. The styrene monomer is emulsified in this system.

The initiator stream is composed of a sodium formaldehyde sulfoxylate reducing agent-iron-ethylene-diamine-tetraacetic acid complex in water. This complex is produced by mixing ferrous sulfate, sodium formaldehyde sulfoxylate, EDTA and TSP in water.

The reaction is monitored continuously by oxidation-reduction potentiometry. At steady state, the redox potential of the reaction mixture is about −650 mV. The reaction mixture is stable at 25° C. in a nitrogen environment for up to six days. The stability can be verified by monitoring the redox potential of the stored mixture over time.

The thus produced polystyrene latex seed composition can be used to seed the subsequent continuous polymerization of butadiene-styrene latex. The seed composition can be produced in advance, collected and stored, and then fed as a stream to a chain of continuous stirred tank reactors. Alternatively, the seed composition can be produced continuously in-line and fed as a stream to the chain of reactors. A significant feature of the invention is that a butadiene-styrene latex can be grown simply by adding butadiene and styrene monomers to the radical-impregnated seed composition emulsion in a sufficiently agitated environment. No additional surfactant or initiator is required.

The drawing schematically illustrates an arrangement of apparatus for carrying out a continuous process for the production of butadiene-styrene latex. To produce the polystyrene seed composition, an emulsion stream 10 and an initiator stream 12 are fed to a seed reactor 14, such as a continuous stirred tank reactor, from respective make-up tanks, not shown. The flow rate of the streams is controlled to provide an average residence time in the seed reactor 14 of from 1 to 15 minutes. The reaction mixture is directed from the seed reactor 14 via an effluent line 20 to the first of a series of polymerization reactors, R₁ . . . Rₙ, such as continuous stirred tank reactors. By way of example, the total number of polymerization reactors may typically range from about 6 to 11. However, the specific number of reactor stages is not a limiting aspect of the present invention.

An emulsion stream 22 containing butadiene and styrene monomers is added to the first reactor R₁, and the reaction mixture is agitated at room temperature to allow the polymerization reaction to proceed. The average residence time in the polymerization reactor R₁ and in each subsequent reactor stage may typically be within the range of from about 60 to about 180 minutes. The reaction mixture is directed to successive reactors R₂ . . . Rₙ via effluent lines 24, and the final butadiene-styrene latex composition is collected from the final reactor Rₙ via an outlet line 26.

The following examples illustrate ways in which the present invention can be carried out. These examples are intended to be illustrative only and should not be construed as limiting the scope of the present invention.

### EXAMPLE 1

Reactor System

A laboratory scale reactor system was assembled in a fame hood from the following components:

1. 5-gallon surfactant vessel with baffle and bottom-feed tubing connections;

2. Surfactant agitator;

3. 500 mL graduated burette for adding oleic acid;

4. Syringe pump and syringe manifold;

5. Foam trap (250 mL round bottom flask);

6. Reactor vessel (500 mL round bottom flask with three openings) fitted with (a.) magnetic stir bar; (b.) tubing connection with valve on outlet; (c.) Stainless steel inlet manifold with sampling port; (d.) Stainless steel initiator inlet; and (e.) ORP probe.

7. Magnetic stirring plate;

8. Diastolic pump;

9. Graduated burette collection vessel; and

10. Seed collection vessel.

The continuous polymerization stirred reactor components were assembled with the surfactant vessel feeding a foam trap and then to the surfactant inlet on the reactor. Two 60 mL syringes on the syringe pump connect to the syringe manifold and then to the initiator inlet on the reactor. The surfactant and initiator lines joined in a static mixer and then fed the reactor. The reactor outlet should then flow into the diastolic pump, graduated burette, and finally the seed collection vessel.

The effluent flow should be calibrated over a desired range after assembly. Upon calibration, the average residence time of the reactor can be calculated by measuring the effluent flow rate and the exact reactor volume in its installed position. The average residence time equals the reactor volume by the effluent flow rate.

### EXAMPLE 2

Raw Materials Preparation

An initial make-up of soap was prepared from the ingredients set forth in Table 1. A separate initiator makeup was prepared by combining the initiator makeup ingredients of Table 2. A final soap makeup is prepared just prior to carrying out the continuous polymerization reaction by mixing the ingredients of Table 3.

TABLE 1

| | | | Charge | |
|---|---|---|---|---|
| | Parts | Activity | Parts | Example Weight (g) |
| Surfactant/Monomer | | | | |
| Composition | | | | |
| Water | 53.45 | 1.00 | 53.179 | 9012.83 |
| Potassium | 0.710 | 1.00 | 0.71 | 120.33 |
| Hydroxide | | | | |
| Oleic Acid | 3.000 | 1.00 | 3.00 | 508.44 |
| Anionic | 0.250 | 0.48 | 0.521 | 88.27 |
| dispersing aid | | | | |
| Potassium Chloride | 0.640 | 1.00 | 0.640 | 108.47 |
| Various | 0.00030 | 0.55 | 0.0005 | 0.084 |
| Hydroperoxide | | | | |
| Styrene | 0.4377 | 1.00 | 0.438 | 74.1 |
| Surfactant Total | | | | 9912.61 |
| Reducing Initiator | | | | |
| Composition | | | | |
| Water | 0.3850 | 1.00 | 0.374 | 63.46 |
| Trisodium | 0.0225 | 1.00 | 0.023 | 3.81 |
| phosphate | | | | |
| EDTA | 0.0100 | 1.00 | 0.010 | 1.69 |
| Ferrous Sulfate | 0.0041 | 1.00 | 0.004 | 0.70 |
| Sodium | 0.0340 | 1.00 | 0.034 | 5.77 |
| formaldehyde | | | | |
| sulfoxylate | | | | |
| Lykopon | 0.0600 | 0.85 | 0.071 | 11.96 |
| Initiator Total | | | | 87.39 |
| Total | 59.00 | | 59.00 | 10000.00 |

### EXAMPLE 3

After priming the reactor with the final soap makeup, the syringe pump was turned on to introduce the flow of initiator into the reactor and measurements were begun of the soap flow rate and initiator flow rate. Once the reactor was running, measurements were made of the Redox potential automatically by the ORP computer and interface. The typical oxidation reduction potential at steady state is about −740 mV.

Styrene consumption was measured by taking samples at 30 minute intervals. The reaction was stopped in the samples and the samples were analyzed by gas chromatography. The seed composition from the reactor was collected and stored in a glass bottle under a nitrogen purge. Measurement of the oxidation reduction potential of the stored seed showed that the seed maintained its oxidation reduction potential for at least 6 days.

Many modifications and other embodiments of the invention will come to mind to one skilled in the art to which this invention pertains having the benefit of the teachings presented in the foregoing descriptions, examples and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A polystyrene seed latex composition having a total emulsion polymer content of from 0.2 to 2.0 weight percent and a particle diameter less than 150 Å.

2. A composition according to claim 1, which also includes excess initiator in an amount sufficient to complete a subsequent continuous latex polymerization.

3. A composition according to claim 2, wherein the initiator comprises a sodium formaldehyde sulfoxylate reducing agent.

4. A composition according to claim 2, wherein the initiator comprises a sodium formaldehyde sulfoxylate-iron-ethylene diamine tetraacetic acid complex.

5. A composition according to claim 1, which also includes from 1 to 8 weight percent of an emulsifier.

6. A composition according to claim 5, wherein the emulsifier comprises potassium oleate.

7. A polystyrene seed latex composition having a total emulsion polymer content of from 0.2 to 2.0 weight percent, a particle diameter within the range of 70 to 120 Å, and from 1 to 8 percent of an emulsifier.

8. A process for producing polystyrene seed latex comprising feeding to a continuous stirred reactor an initiator stream comprising a reducing agent-iron-EDTA complex and an emulsion stream comprising emulsified styrene, providing the streams a residence time in the reactor to react and form a polystyrene seed latex composition having a total emulsion polymer content of from 0.2 to 2.0 weight percent and a particle diameter less than 150Å, and removing the polystyrene seed latex composition from the reactor.

9. A process according to claim 8, wherein the step of feeding an emulsion stream comprises feeding a stream of 0.2 to 2 weight percent styrene in an aqueous emulsion.

10. A process according to claim 9, wherein the aqueous emulsion comprises potassium oleate emulsifier.

11. A process according to claim 10, wherein the potassium oleate emulsifier is present in an amount of from 1 to 8 weight percent in water.

12. A process according to claim 10, wherein at least one of the feed streams also includes hydroperoxide.

13. A process for producing polystyrene -butadiene latex comprising feeding to a continuous stirred reactor a stream of the polystyrene seed latex composition of claim 1 and a monomer stream of styrene and butadiene, and reacting the streams in the absence of added surfactant or initiator.

14. A process for producing polystyrene seed latex comprising feeding to a continuous stirred reactor an initiator stream comprising a sodium formaldehyde sulfoxylate reducing agent-iron EDTA complex, also feeding to the reactor an emulsion stream comprising styrene emulsified in water by an emulsifying agent, and providing the streams a residence time in the reactor of 1 to 15 minutes to react and form a polystyrene seed latex composition having a total emulsion polymer content of from 0.2 to 2.0 weight percent and a particle diameter less than 150 Å.

15. A process according to claim 14, wherein the feeding of an emulsion stream comprises feeding a steam of 0.2 to 2 percent by weight styrene emulsified by 1 to 8 weight percent potassium oleate in water.
